(19) United States
(12) Patent Application Publication
(10) Pub. No.: US 2007/0210541 A1
(43) Pub. Date: Sep. 13, 2007

(54) MOLDED SHOPPING CART AND METHOD OF MOLDING A SHOPPING CART

(76) Inventor: Christopher M. Johnson, Glen Allen, VA (US)

Correspondence Address: MCGUIREWOODS, LLP, 1750 TYSONS BLVD, SUITE 1800, MCLEAN, VA, 22102, US

(21) Appl. No.: 11/683,240

(22) Filed: Mar. 7, 2007

Related U.S. Application Data
(60) Provisional application No. 60/779,435, filed on Mar. 7, 2006.

(51) Int. Cl. B62D 39/00

(52) U.S. Cl. 280/33.991

(57) ABSTRACT

A shopping cart includes a molded basket, a molded basket support that is connected to and is configured to support the molded basket, and a molded lower tray frame that is connected to and is configured to support the molded basket support. The molded basket, molded basket support and lower tray frame may be molded together during a molding process.

### CROSS-REFERENCE TO RELATED APPLICATIONS

This application claims priority under 35 U.S.C. §119(e) to provisional U.S. Patent Application No. 60/779,435, filed on Mar. 7, 2006, the disclosure of which is expressly incorporated by reference herein in its entirety.

### BACKGROUND OF THE INVENTION

1. Field of the Invention

The invention is directed to a shopping cart that is constructed with a reduced number of components. More particularly, a shopping cart constructed of a reduced number of molded components.

2. Related Art

A majority of shopping carts used in grocery stores and other retail establishments have molded components. However, these shopping carts still have a number of components that hold the molded components of the shopping cart and/or have a large number of molded components. Such a large number of components typically require more manufacturing steps, are susceptible to corrosion, more likely break, and are less attractive.

Accordingly, there is a need for a shopping cart that has a simple and attractive molded construction with a reduced number of components.

### SUMMARY OF THE INVENTION

The invention meets the foregoing needs and provides for a shopping cart constructed with a single or reduced number of major molded components which results in a significantly less expensive shopping cart that will not easily corrode, that is very attractive, and also includes other advantages apparent from discussion herein.

Accordingly, in one aspect of the invention a shopping cart includes a molded basket, a molded basket support that is connected to and is configured to support said molded basket, and a molded lower tray frame that is connected to and is configured to support the molded basket support.

According to another aspect of the invention a method of substantially molding a shopping cart includes the steps of molding a shopping cart basket, molding a shopping cart basket support, and molding a shopping cart lower tray frame.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a shopping cart constructed according to the principles of the invention;

FIG. 2 shows a specific embodiment of a shopping cart constructed according to the principles of the invention;

FIG. 3 shows a right side perspective view of the shopping cart of FIG. 1;

FIG. 4 shows a rear left side perspective view of the shopping cart of FIG. 1;

FIG. 5 shows a top view of the shopping cart of FIG. 1;

FIG. 6 shows a front view of the shopping cart of FIG. 1;

FIG. 7 shows a left side view of the shopping cart of FIG. 1;

FIG. 8 shows a rear side view of the shopping cart of FIG. 1;

FIG. 9 shows a left side view of an embodiment of a shopping cart having an exemplary molded basket web pattern constructed according to the principles of the invention;

FIG. 10 shows a rear left side perspective view of the shopping cart with gate constructed according to the principles of the invention;

FIGS. 11 and 12 show another embodiment of a shopping cart having an exemplary molded basket and tray web pattern constructed according to the principles of the invention; and

FIG. 13 shows an exemplary process of molding a shopping cart according to the principles of the invention.

### DETAILED DESCRIPTION OF THE INVENTION

The embodiments of the invention and the various features and advantageous details thereof are explained more fully with reference to the non-limiting embodiments and example that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

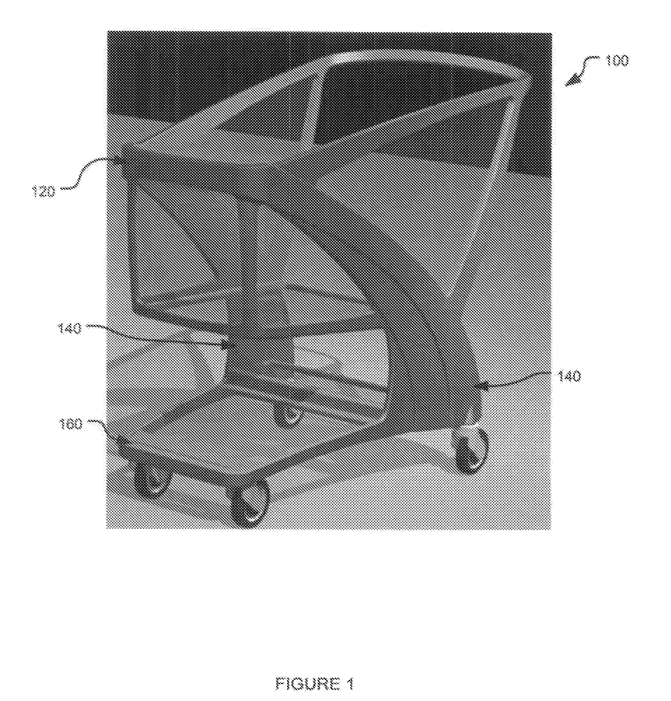

FIG. 1 shows a shopping cart constructed according to the principles of the invention. In particular, FIG. 1 shows a shopping cart 100 that includes a lower tray frame 160 that may support a lower tray 170. A basket support 140 is connected to the lower tray frame 160. The basket support 140 may have a thicker construction at a lower end, as shown by FIG. 1, to withstand the increased forces at that location. In this regard, the basket support 140 is shaped to accommodate the forces applied to the shopping cart 100. The lower tray frame 160 may be integrally molded with the basket support 140. A shopping cart basket 120 may be connected to the basket support 140. Moreover, basket support 140 may be integrally molded with the shopping cart basket 120. Additionally, the lower tray frame 160 and the lower tray 170 may be integrally molded. The lower tray 170 and portions of the basket 120 may be formed of a molded web structure. As shown in FIG. 1, the integral construction of the lower tray frame 160, the basket support 140, the lower tray 170 and the basket 120 creates a single continuous structure that has increased strength, rigidity, and reduced cost of manufacture. The shopping cart 100 may include more or less components then shown in FIG. 1. The single molded structure reduces the need for fasteners and reduces manufacturing time, labor, and costs.

The construction shown in FIG. 1 may be accomplished through a reduced number of molded structures. The molded structure may be made using any one or more of the molding processes disclosed in the U.S. Pat. No. 6,589,458 issued Jul. 8, 2003 at DeCost, expressly incorporated herein by reference in its entirety.

The shopping cart 100 may also be constructed of multiple types of materials, such as plastic, nylon, fiberglass, or any other type of synthetic material and the like. In one aspect, the shopping cart 100 may be constructed using a co-injection process. The co-injection process may allow for the use of a plurality of different material types, or types of plastic, to be injected and used in the molding process to form the shopping cart 100.

Although the shopping cart 100 shown in FIG. 1 has a specific construction and arrangement of the lower tray frame 160, the basket support 140, and the basket 120, any combination, arrangement, and/or configuration of these structures may be utilized and is contemplated for use in the invention herein.

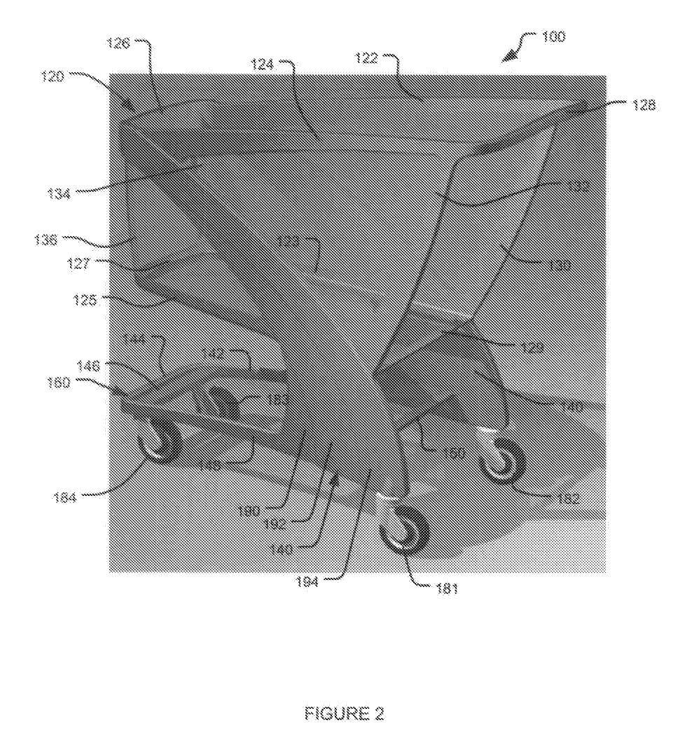

FIG. 2 shows a specific embodiment of a shopping cart 100 constructed according to the principles of the invention. In particular, as shown in FIG. 2, the basket 120 may include upper basket frame sides 122, 124. The basket 120 may also include an upper basket frame front 126. The upper basket frame front 126 and the upper basket frame sides 122, 124 are connected to four vertical supports, 130, 132, 134, 136. In particular, the vertical supports 130, 132, 134, 136 may be connected to the upper frame front 126 and the upper basket frame sides 122, 124. Further, the vertical supports 130, 132, 134, 136 may extend down to a bottom of the basket 120. More specifically, the vertical supports 130, 132, 134, 136 extend to the bottom of the basket 120 and connect to lower basket frame sides 123, 125. The vertical supports 130, 132, 134, 136 may also extend to connect to a lower basket frame front 127 and a lower basket frame rear 129. The basket 120 may have a rear opening between vertical supports 130, 132. Accordingly, the basket 120 may be a single molded structure that has a construction that is rigid and also has reduced manufacturing costs and a reduced number of separate components. Alternatively, any one of these components may be excluded from the molded structure.

Additionally, the basket 120 may include a retaining structure for retaining items in the basket 120 such as a web pattern of material between each of the upper basket frame sides 122, 124, upper basket frame 126, vertical supports 130, 132, 134, 136 and the lower basket frame sides 123, 125 and the front and rear lower basket frame parts 127 and 129. This web material may also be molded during the construction of these components.

As further shown in FIG. 2, the lower tray frame 160 may be molded together with the basket support 140 and/or the basket 120. The lower tray frame 160 includes lower tray frame sides 142, 148. The lower tray frame sides 142, 148 may be connected to one another by a lower tray frame front cross member 146 and lower tray frame rear cross member 150. Additionally, the lower tray frame 160 includes a lower tray frame front 144. Again, the lower tray frame components may be molded concurrently with the lower tray frame 160. In particular, the lower tray frame 160 may be concurrently molded with all of the components including the lower tray cross member 150, lower tray frame side one 142, 148, lower tray frame cross member 146 and lower tray frame front 144. Additionally, the lower tray frame 160 may be molded with one or both the basket 120 and basket support 140. Moreover, the basket support 140 may also include rib structures 190, 192, 194 to provide rigidity as needed.

Additionally, the shopping cart 100 may include a shopping cart handle 128 which may also be molded with one or more of the other components of the shopping cart 100.

The lower tray frame 160 further includes molded structure to connect the lower frame 160 to a plurality of shopping cart casters 181, 182, 183, 184. The shopping cart casters 181, 182, 183, 184 need not be constructed of a plastic material or molded with the basket 120, basket support 140, and lower tray frame 160. In fact, the invention contemplates these structures being metallic and/or rubber construction, or the like. However, these structures may be separately molded from a plastic material.

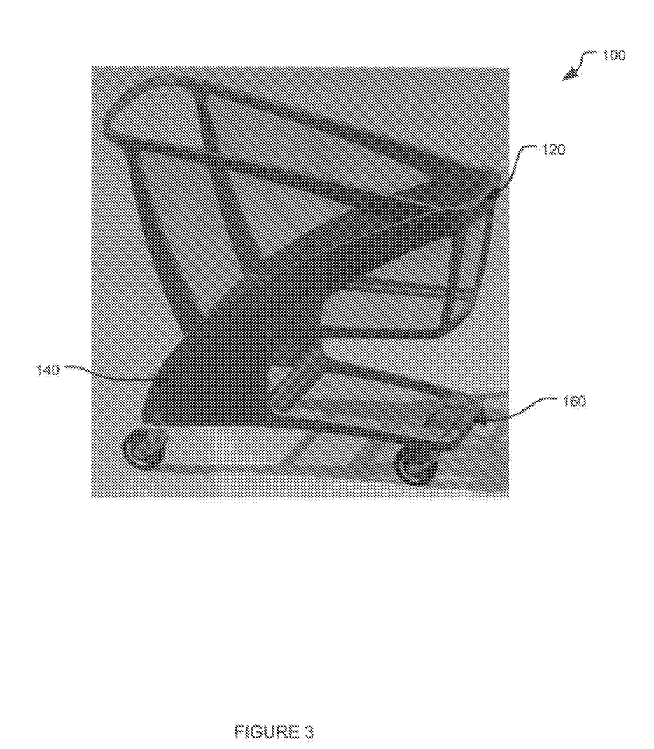

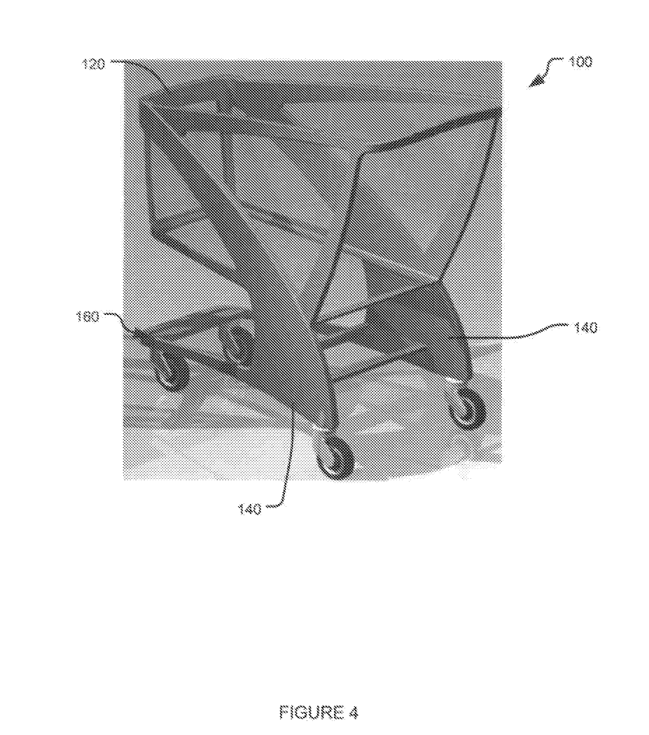

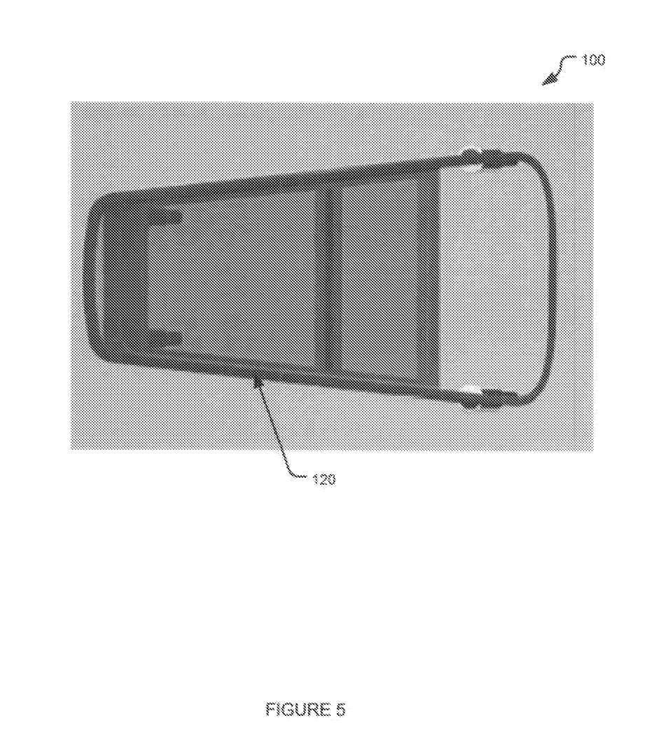

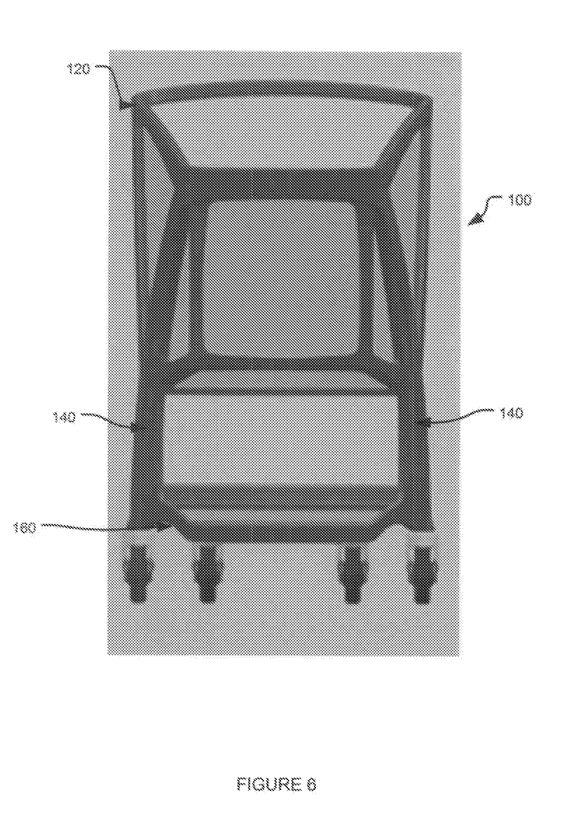

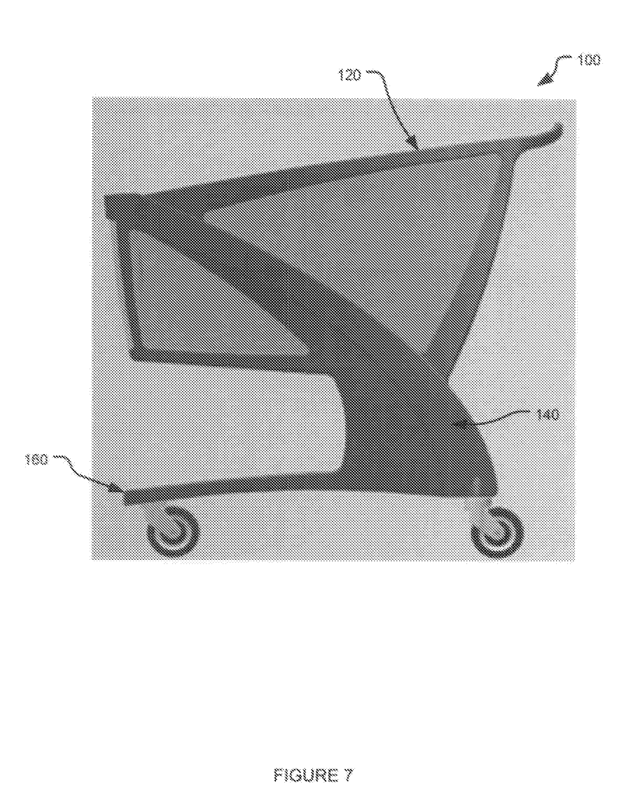

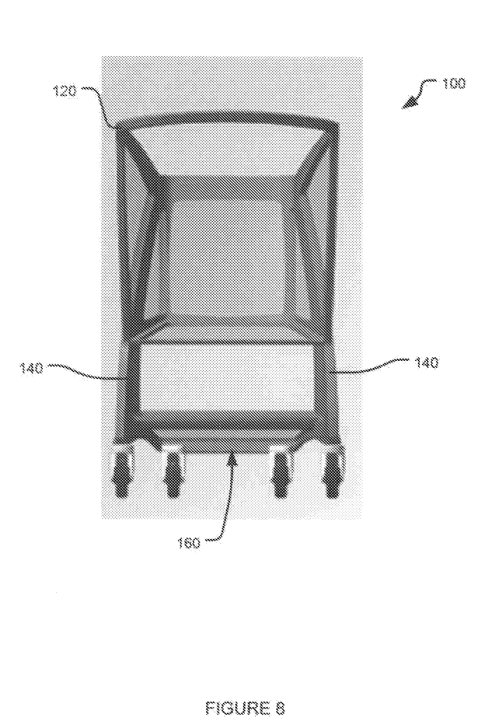

FIGS. 3-9 show various views of the shopping cart 100. FIG. 3 shows a right side perspective view of the shopping cart construction according to the principles of the invention. FIG. 4 shows a rear left side perspective view of the shopping cart according to FIG. 1. FIG. 5 shows an upper view of the shopping cart construction according to FIG. 1. FIG. 6 shows a front view of the shopping cart constructed according to FIG. 1. FIG. 7 shows a left side view of the shopping constructed according to FIG. 1. FIG. 8 shows a rear view of the shopping cart constructed according to FIG. 1.

Again, it should be noted that each of FIGS. 1-8 show a particular configuration of the shopping cart 100. However, it should be noted that these are merely exemplary arrangements of the various shopping cart components.

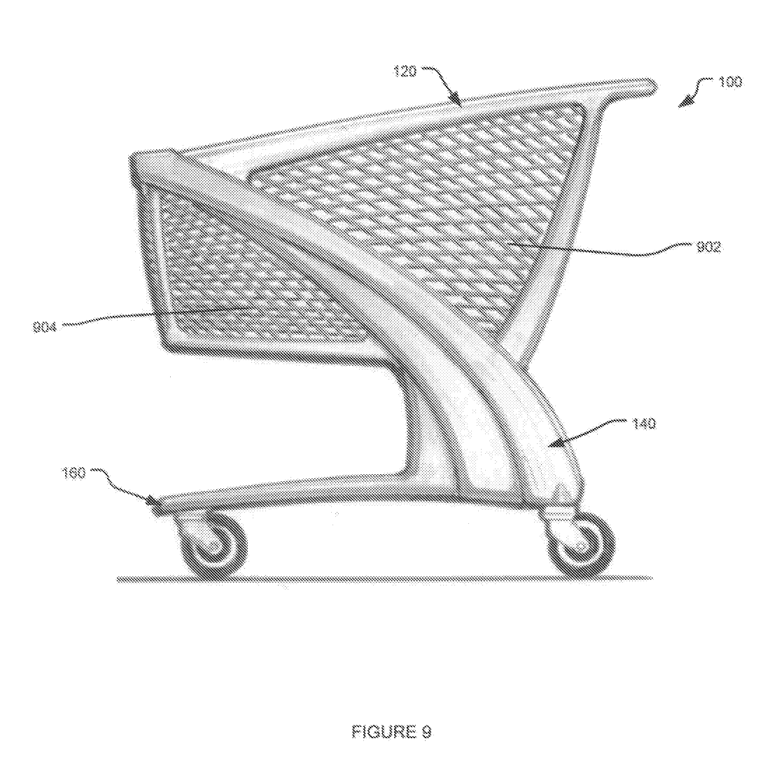

FIG. 9 shows a left side view of another embodiment of the shopping cart having an exemplary molded web pattern 902, 904 constructed according to the principles of the invention. In particular, FIG. 9 shows an exemplary web pattern 902, 904 that may be interconnected to the various vertical side frame components of the basket 120 of the shopping cart 100.

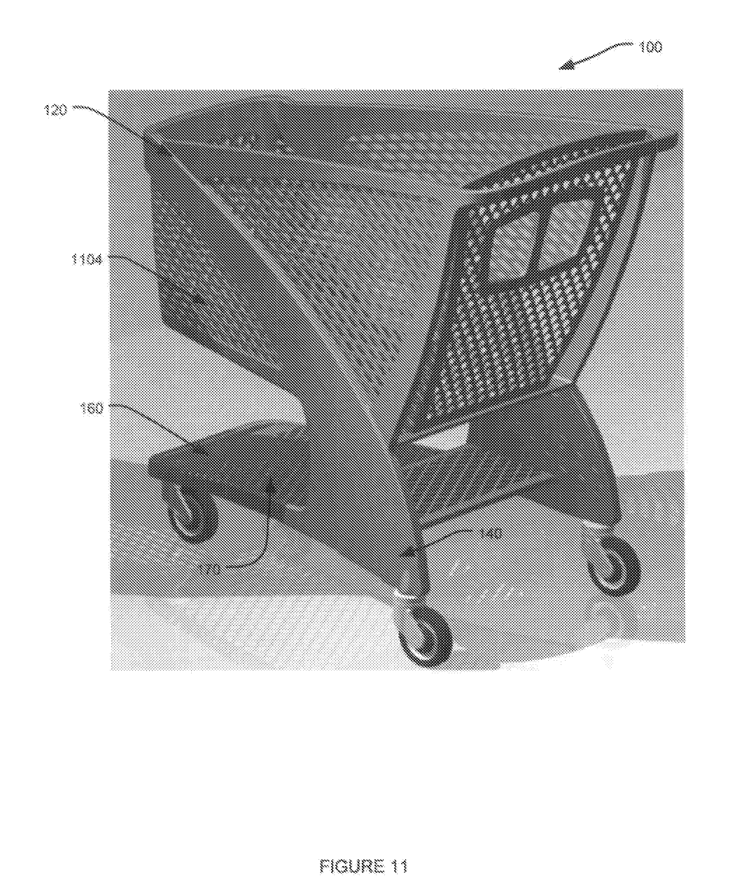

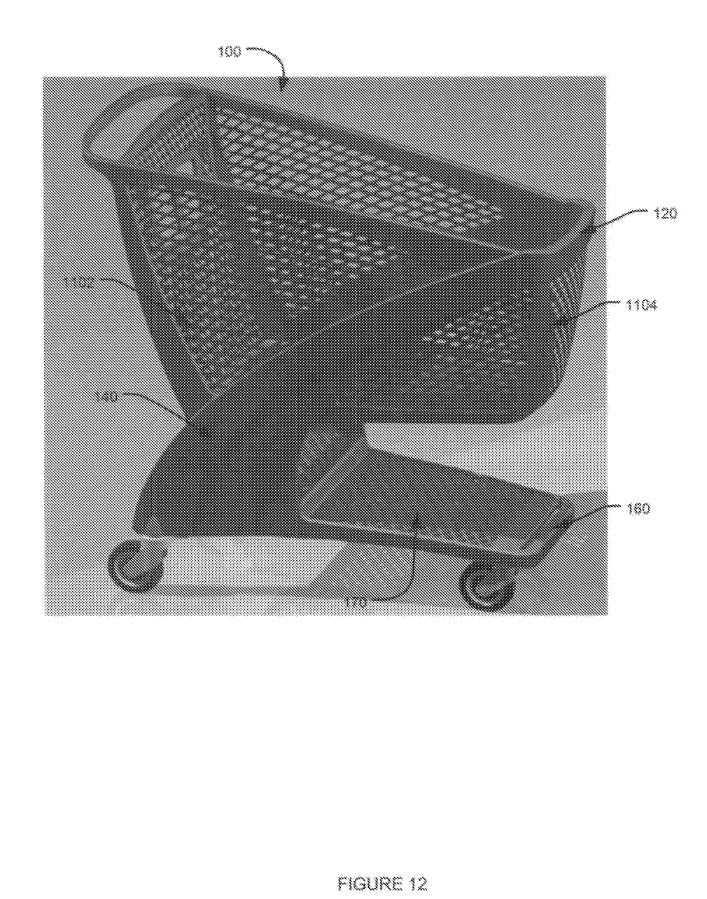

FIGS. 11 and 12 show another embodiment of the shopping cart 100 having an exemplary molded web pattern 1102, 1104 constructed according to the principles of the invention. Furthermore, FIGS. 11 and 12 show an exemplary web pattern for the lower tray 170 of the shopping cart 100. The lower tray frame 160 and the lower tray 170 may be integrally molded and may further be integrally molded with any of the other components of the cart 100.

It should be noted that any type of web construction including plastic, nylon, fabric knitting, or the like may be used to connect the various sides of the vertical members to form the above-described embodiments of the basket 120 in order to form the retaining structure. Moreover, a vertical, horizontal, or octagon shaped mesh web pattern, or the like are also contemplated for use in any of the embodiments of the molded shopping cart 100 of the invention.

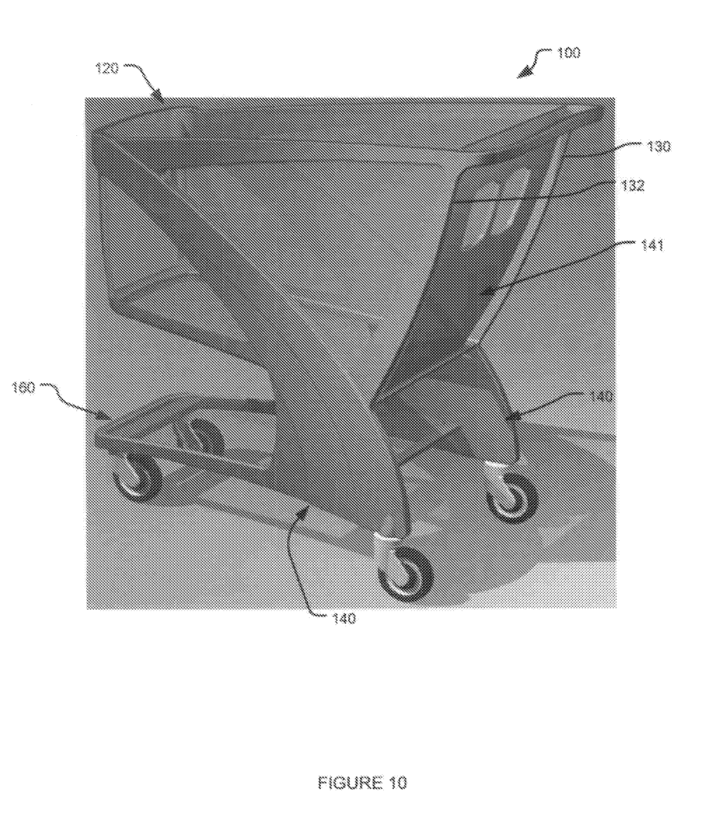

The shopping cart 100 may also include a gate assembly 141 as shown in FIG. 10. The gate assembly 141 may be integrally molded with the rest of the shopping cart 100 and then removed from the molded structure to be reattached or may just be separately molded. In particular, the gate structure 141 is hinged at the top of the basket 120 between the upper frame basket sides 130, 132. The gate assembly 141 allows for another shopping cart 100 to be inserted from the rear to concatenate the shopping carts together for storage and transportation as is known in the art.

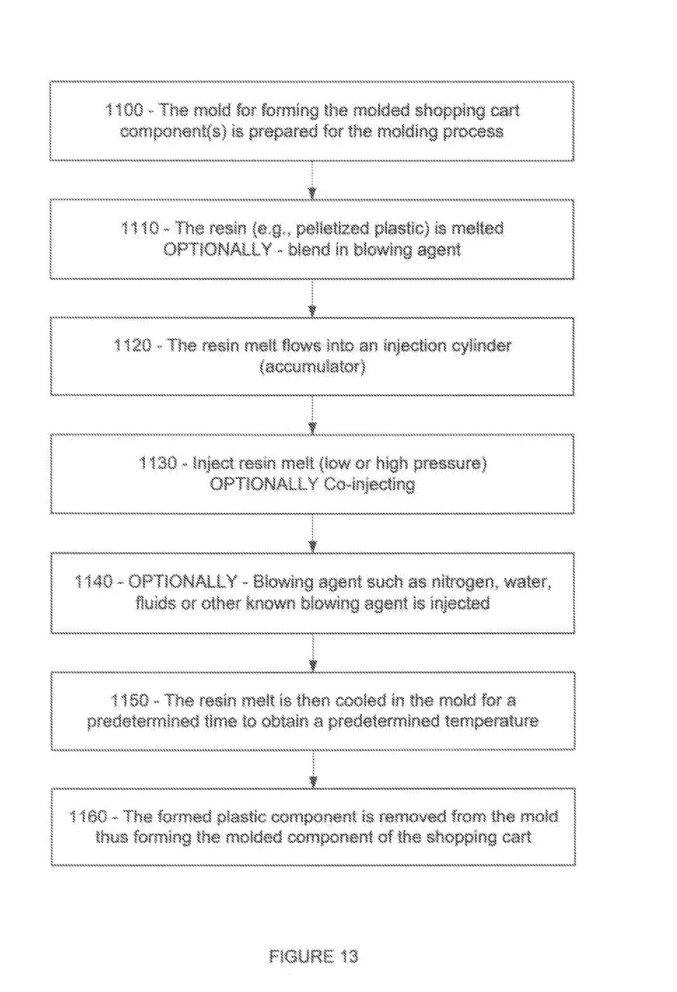

Referring now to FIG. 13, a flow chart describing a low or high pressure gas assist injection molding process that may be used for molding the shopping cart of the invention is shown. In step 1100, the mold for forming the molded component (by flowing the resin melt (for example polyolefin or engineering thermoplastics)) is prepared for the molding process. The mold is representative of multiple components of the shopping cart such as the basket support 140 and the basket 120, and may represent any size or shape thereof. The mold may equally represent the entire shopping cart 100. By way of example, the mold may be used to form the basket 120, the basket support 140, and the lower tray frame 160 as shown in FIG. 1.

In step 1110, the resin (e.g., pelletized plastic) is melted (plasticized) by both pressure and heat or other known methods. The heating temperatures for melting the resin may vary depending on the particular resin material used by the method of the invention. For example, a thermoplastic engineering material may be heated to a temperature of between approximately 450° F. to 550° F., whereas a polyolefin material may be heated to a temperature between approximately 350° F. to 450° F. Further in step 1110, a blowing agent may optionally be blended to form a component with the “foam” characteristics.

In step 1120, the resin melt flows into an injection cylinder (accumulator). The pressure within the accumulator of the molding machine during the injection stage may be either high pressure or low pressure. Once the accumulator is loaded with a predetermined amount of resin melt (the shot), the injection cylinder ram may force (inject) the resin melt through one or more nozzles into the cavity of the mold as shown by step 1130. Additional injecting may be done through the above-noted co-injection process.

In step 1140, a blowing agent such as nitrogen, water, fluids or other known blowing agent may be optionally injected into a cavity of the mold via a hole placed with a nozzle opening/closing device or other known mechanism. In the embodiments, the blowing agent may begin to be injected into the stream of the resin melt after approximately 60 to 90% of the resin melt is force into the mold. It should be understood, however, that the blowing agent may also be injected into the stream of the resin melt prior to 60% or subsequent to 90% of the resin melt being forced into the mold. The blowing agent is injected into the mold resulting in laminar flow, and may be used to reduce the density of the resin melt to approximately 70% to 95% of the original density. In this step, the blowing agent will force the resin melt against the side walls of the mold thereby forming a hollow center channel within the molded component. It is noted that the amount of blowing agent (and resin melt) flowing into the mold may depend on several variables including, but not limited to, (i) the desired thickness of the walls of the molded component, (ii) the desired diameter of the hollow center channel within the molded component and (iii) the size and shape of the mold (or desired cart), itself.

In step 1150, the resin melt is then cooled in the mold for a predetermined time to obtain a predetermined temperature. This allows the resin melt to properly form into the molded component. For example, a thermoplastic engineering material may be cooled to a temperature of between approximately 100° F. to 200° F. On the other hand, a polyolefin material may be cooled to a temperature of between approximately 90° F. to 160° F. Of course, cooling times may depend on several variables such as the amount of resin melt injected into the mold, the wall thickness of the molded component and the like.

In step 1160, the formed plastic component is removed from the mold thus forming the molded component of the shopping cart 100.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A shopping cart comprising:
a molded basket;
a molded basket support that is connected to and is configured to support said molded basket; and
a molded lower tray frame that is connected to and is configured to support said molded basket support,
wherein said molded basket is integrally molded with said molded basket support.

2. The shopping cart according to claim 1 wherein said molded basket comprises a shopping cart handle.

3. The shopping cart according to claim 1 wherein said molded basket comprises upper frame sides.

4. the shopping cart according to claim 3 wherein said molded basket comprises vertical supports.

5. The shopping cart according to claim 4 wherein said molded basket comprises lower basket frame sides.

6. The shopping cart according to claim 1 further comprising:
a lower tray that is supported by the lower tray frame,
wherein said lower tray and said lower tray frame are integrally molded with said molded basket support.

7. The shopping cart according to claim 1 wherein said basket support is integrally molded with said lower tray frame.

8. The shopping cart according to claim 1 wherein said molded lower tray frame comprises lower tray frame sides.

9. The shopping cart according to claim 8 wherein said molded lower tray frame comprises lower tray frame cross members.

10. The shopping cart according to claim 1 wherein said molded lower tray frame is configured to mount casters.

11. The shopping cart according to claim 1 wherein said molded lower tray frame is integrally molded with said molded basket support.

12. The shopping cart according to claim 1 wherein said molded lower tray frame, said molded basket support and said molded basket are integrally molded.

13. The shopping cart according to claim 1 wherein said molded lower tray frame, said molded basket supports, and said molded basket are integrally molded by co-injection molding.

14. A method of molding a shopping cart comprising the steps of:
molding a shopping cart basket;
molding a shopping cart basket support; and
molding a shopping cart lower tray frame,
wherein said steps of molding comprise integrally molding the shopping cart basket and the shopping cart basket support.

15. The method according to claim 14 further comprising the step integrally the cart lower tray frame with a lower tray.

16. The method according to claim 15 wherein the steps of molding comprise molding the shopping cart basket and the shopping cart basket support together with the shopping cart lower tray frame.

17. The method according to claim 14 wherein said basket further comprises a web structure.

18. A shopping cart comprising:
a molded basket;
a molded basket support that is connected to and is configured to support said molded basket; and
a molded lower tray frame that is connected to and is configured to support said molded basket support,
wherein said molded basket is integrally molded with said molded lower tray frame.

19. The shopping cart according to claim 18 wherein said molded lower tray frame, said molded basket supports, and said molded basket are integrally molded by co-injection molding.
